(19) United States
(12) Patent Application Publication
(10) Pub. No.: US 2019/0136836 A1
(43) Pub. Date: May 9, 2019

(54) Apparatus and Method for Repairing Fibre-Composite Structures

(71) Applicant: Rotos 360 Limited, Norfolk (GB)

(72) Inventor: Simon Sanderson, Norfol (GB)

(21) Appl. No.: 16/099,946

(22) PCT Filed: May 10, 2017
(86) PCT No.: PCT/GB2017/051302

§ 371 Date: Nov. 8, 2018

(30) Foreign Application Priority Data
May 11, 2016 (GB) 1608263.8

(51) Int. Cl. F03D 80/50; B08B 15/02; B25J 21/02

(52) U.S. Cl. CPC F03D 80/50; F05B 2230/80; B25J 21/02; B08B 15/026

(57) ABSTRACT

Repairs need to be carried out on various structures in outdoor climatic conditions, which may be in wind or rain. Such a structure may be a wind turbine blade (1). This limits the time when the repairs can be conducted while conditions are within the limits set for the process. The invention provides an enclosure (4) which can be sealed to the structure so that a repair can be conducted at any desired time. The enclosure is large enough to enclose a desired work area with the operator's hands and arms entering to carry out the work through hand and arm seals (6, 7).

### FIELD OF INVENTION

The present invention relates to an apparatus and a method for repairing structures such as wind turbine blades. In particular, the invention relates to an apparatus and a method for providing an environment suitable for carrying out such repairs.

### BACKGROUND OF THE INVENTION

It is advantageous for some types of composite and other repairs and essential for other types of composite and other repairs to maintain a constant temperature and humidity of the component being repaired.

If the ambient temperature is too low or high, or the ambient humidity is too high it is advantageous to enclose the working area for the repair within an enclosure in which the temperature and humidity can be controlled.

A number of temporary enclosures for use to repair damages of onshore and offshore structures have been proposed, some for repair work on elevated areas of the damaged structures. Most devices enclose the whole or part of the structure being repaired plus the person conducting the repair and sometimes also the access platform.

The present invention aims to solve a number of problems in these prior designs.

Patent GB2518701 Fletcher describes a temporary maintenance enclosure for maintenance of wind turbine blades for that substantially surrounds and encloses the operators, platform and the blade and uses inflatable elements to help support its structure.

Patent DE19909698 Siebert et al describes a working cabin made of plastic, aluminium or the like, that accommodates areas of the rotor blades and includes sealing devices for carrying out maintenance and renovation work on wind turbine blades. This surrounds the blade allowing operators to work inside the cabin sheltered from the environment.

Patent DE102010011365 Duchow et al describes a weather protection device for working platforms on wind turbine blades, comprises base element and parapet, and receiving unit for receiving two inflatable elements. Again this surrounds the blade allowing repair operators to work inside an enclosure sheltered from the environment.

Patent DE202009002054 Hansen describes a weather protection device that surrounds a substantial length of the wind turbine blade.

Patent U.S. Pat. No. 8,720,058 Anasis et al describes a method of repairing a mounted wind turbine blade using a containment structure suspended from a nacelle via a hoisting system. The damaged portion is enclosed within a containment structure and the temperature of the air within the containment structure is controlled.

Bladefence Oy, Finland, has previously reported that it has deployed a temporary suspended shelter to repair a damaged blade in winter, in a conference presentation (“Cold climate rotor blade repairs using advanced UV curing resin system” Ville Karkkolainen, Winterwind 2014 www.winterwind.se/sundsvall-2014/presentations-2014/?edmc=2777) and a published article (“New materials and methods promise blade repairs in winter” Windpower Engineering & Development, 20 Oct. 2014 http://www.windpowerengineering.com/design/materials/new-materials-methods-promise-blade-repairs-winter/). The enclosure depicted is a rigid box that surrounds the blade and can contain several operators.

All of this prior art presents large enclosures that enclose the operators doing the work, a substantial expanse of the blade, as well as in many cases most of the access platform. Therefore these devices are inherently large, cumbersome and have large cross-sections that tend to catch the wind.

### SUMMARY OF INVENTION

The invention provides an apparatus and a method as defined in the appended independent claims, to which reference should now be made. Preferred or advantageous features of the invention are set out in dependent sub-claims.

In a first aspect, the invention may thus provide a temporary enclosure with climate control that provides a controlled environment for carrying out work such as repairs on structures such as onshore and offshore wind turbine blades. When the weather conditions are not suitable for conducting a repair, the temporary enclosure may be sealed onto the work area using a seal. The person or persons conducting the repair (the operator(s)) can put their hands and arms through arm holes or sleeves in the enclosure wall to conduct the work. The arm holes may be open at their ends, or may be closed in the manner of the gloves in a glove box. The enclosure incorporates essentially transparent panels so the operator can see the area being repaired. Materials and tools may be introduced into the enclosure through a resealable port. Power and lighting may be provided inside the enclosure.

In a preferred embodiment, the temperature, humidity and dust inside the enclosure may be controlled by introducing air, which may be conditioned air, through a duct from an air supply or from a climate control box. Sensors inside the enclosure may be provided to display, monitor and feed data back to a control box to control, and record internal conditions and activity.

Repairs may need to be carried out on various structures in outdoor climatic conditions, which may be in wind or rain. Such a structure may be a wind turbine blade. The work could be repairs involving composite materials or painting or dismantling and replacement of parts or inspection and test or other operation. Conventionally, the need to control environmental conditions for the work limits the time when a repair in outdoor climatic conditions can be conducted to when the ambient conditions are within the limits set for the process. For example, apart from the inconvenience and difficulty of working in wind and rain, a repair of a fibre-composite structure may involve the use of materials that require dry conditions, or a particular temperature range, or a particular air humidity range, to function correctly. An enclosure embodying the invention may provide a suitable environment for carrying out such work independently of the outdoor climatic conditions.

A preferred embodiment of the invention may thus provide an enclosure which can be sealed to the structure, optionally enclosing a controlled atmosphere, so that a repair can be conducted at any desired time. The enclosure is large enough to enclose a desired work area with the operator's hands and arms entering to carry out the work through hand and arm seals. Additionally the power consumption and windage of the enclosure may be advantageously small because the size of the enclosure is minimised by comparison to prior art apparatus, to optimise its operation.

In a preferred embodiment the present invention may thus provide a temporary enclosure with climate control for conducting composite or other repairs where the temperature and humidity has to be controlled to be within set parameters for the repair system being employed. Embodiments of the invention may comprise some or all of the following elements.

An enclosure in which the repair is carried out provides a climate controlled area protected from rainfall, wind and contamination. The enclosure is deployed temporarily around the work area.

In a preferred embodiment, the enclosure is made partially or substantially from flexible or semi-rigid materials. In a preferred embodiment, it incorporates rigid or partially rigid members such as battens, poles, tubes or rods to support its shape and structure.

In a preferred embodiment, the enclosure may be flexible, or part of the enclosure may be flexible, and the air pressure inside the enclosure may be maintained above ambient air pressure in order to maintain or reinforce the shape of the enclosure.

In a preferred embodiment, the enclosure is attached around the work area with the aid of straps, guy lines, webbing, elastic cord, adhesive materials, magnets, suction, pressure or other means. The enclosure is held in position and tensioned to achieve the desired shape using means such as guy lines, cords, straps, poles, battens, etc., attached and adjusted with clips, karabiners, buckles, runners, linelocks, hooks, rings, knots, etc. to the work structure or access platform.

In a preferred embodiment, the enclosure is attachable to the structure under repair with a plurality of removable anchoring means, such as suction cups. The suction cups (or other removable anchors) are advantageously separable from the enclosure, so that they may be attached to the structure in desired positions around the work area. The enclosure may then be fixed in position by attaching portions of the enclosure to the suction cups, to enclose the work area of the structure in need of repair. Optionally, the enclosure may be attachable to one or more suction cups so as to tension the enclosure to achieve a desired shape. Preferably the enclosure is attachable to the suction cups at its corners, or at positions along its edges, using karabiners, or adjustable straps. The positions of the suction cups, or the length of the straps, may be adjusted to tension the material of the enclosure so that it takes up its intended position and/or shape.

In a preferred embodiment, the enclosure is attachable to a metallic surface with removable anchoring means in the form of a plurality of magnets. Preferably the magnets are arranged around the perimeter of the enclosure, so as to attach the enclosure to the metallic surface around its edges.

In a preferred embodiment, the enclosure is made from a waterproof fabric material and keeps the enclosed area dry when used in rain.

In a preferred embodiment, the enclosure is partly or substantially constructed of fabric or laminated material or other material that is essential transparent, or incorporates transparent panels, through which the work can be seen from outside of the enclosure.

In a preferred embodiment, the enclosure attaches around the perimeter of the work area with a seal to the surface of the blade or structure, maintaining its contact with the surface through suction, adhesive, pressure, tension, or other means.

In a preferred embodiment, the perimeter of the enclosure seals around the work area by tension when the enclosure is tensioned to take up its intended position and/or shape. When the corners of the enclosure are urged or pulled apart to attach the enclosure to the structure, for example, the perimeter of the enclosure may be biased against the structure by tension so as to form a seal.

The seal to the surface of the blade or structure may not be completely airtight. The seal need only be sufficiently airtight to allow the establishment of the desired controlled atmosphere inside the enclosure, and to prevent or reduce the ingress of outside contaminants. For example, where a positive pressure is desired inside the enclosure, the seal around the perimeter may allow the escape of some air, as long as the positive pressure inside the enclosure can be maintained at the desired level.

In a preferred embodiment the enclosure comprises a strip of fabric webbing around its perimeter. When the enclosure is attached to the blade or structure, the webbing forms a seal to the surface of the blade or structure, and maintains its contact with the surface through tension. The fabric webbing may be rubberised, or comprise a rubber portion or strip, on at least one side, in order to increase friction between the webbing and the surface to which it is attached.

In a preferred embodiment, a vacuum seal (or reduced-pressure seal) may extend around at least a part of the perimeter of the enclosure that abuts the blade or structure during operation of the enclosure, and the air pressure within the seal is reduced by means of a vacuum pump or suction pump so that atmospheric pressure urges the seal into close contact with the surface. In a preferred embodiment, the seal is made from a flexible elastomeric material such as extruded silicone rubber. In a preferred embodiment, the seal has a cross-section which incorporates flanges that may be smooth or ridged so as to make close contact with the surface, an internal bore through which air may be extracted, and a flange or flanges or similar feature by which the seal may be attached to the body of the enclosure by stitching or adhesive or other means.

In an alternative embodiment, the perimeter of the enclosure can be sealed to the structure temporarily using adhesive tape.

In either case, the seal holds the enclosure in position, reduces loss of conditioned air from within the enclosure and prevents entry of rain water and other contamination.

In a preferred embodiment, the seal is securable by the vacuum seal, or otherwise sealed onto the blade or structure, around the edge of the enclosed work area even when the surface of the blade or structure is wet, so that the enclosure can be applied while it is raining. Where a vacuum is used, the vacuum advantageously only applies to the seal itself, and is separate from the atmosphere in the enclosure.

In a preferred embodiment, the enclosure may include flexible battens or poles to hold its structure in the desired shape. In a preferred embodiment, the enclosure includes a rigid platform at its base that can be used as a work table for tools and materials.

It is envisioned that the enclosure has holes into which an operator can insert his or her hands and arms, through which the operator conducts the work, allowing the operator have access to the area inside the enclosure, while stopping the escape of the conditioned air from the enclosure. In a preferred embodiment, the arm holes have flexible sleeves with adjustable seals around the operators' wrists or elbows. The seals incorporate elastic cuffs or draw cords or a hook-and-loop material such as Velcro® or other means so that they can be adjusted for a comfortable fit, allowing freedom of movement, while providing an effective seal against egress of the conditioned air. In an alternative embodiment, the sleeves in enclosure can incorporate gloves. In a preferred embodiment, there is provision for two arm holes allowing one operator to use both arms, but additional sleeves could be provided for more operators or to allow the operator to work in different positions.

As the operator is located outside the enclosure, the atmosphere inside the enclosure may even be unsuitable for breathing by the operator, if required for carrying out a repair or other operation. Working with composite materials may involve solvents or other volatile substances that should not be inhaled by the operator.

Optionally, the enclosure may incorporate one or more ports for introducing and removing tools, repair materials and other items needed to carry out the work. In a preferred embodiment, these may be opened to pass items as required and closed using a closure device such as a zip fastener, hook-and-loop material such as Velcro®, lacing, buttons, press studs, hook-and-eye closure or magnetic strips, to create a flexible or partially flexible access port that can be resealed. In an alternative embodiment, the enclosure may incorporate one or more rigid or semi-rigid access hatches, doors or air locks.

Optionally, the enclosure may incorporate a means for the supply of power to tools and equipment in the enclosure. In one embodiment, the enclosure may incorporate ports through which electrical or pneumatic or hydraulic or mechanical or thermal or other form of power can be made available within the enclosure. In a preferred embodiment, a port may be opened to pass the cable or hose as required and closed using a closure device as above. In an alternative embodiment, power outlet sockets can be provided within the enclosure. In an alternative embodiment, a port can allow electronic instrumentation and signal cables to be linked.

Optionally, the enclosure may incorporate lighting to illuminate the work area.

Optionally, the enclosure may incorporate sensors, instrumentation and monitoring equipment such as thermometers, humidity sensors, video cameras, timers, weather instruments for example temperature, wind speed, humidity; location or position sensors for example based on the Global Positioning System (GPS); to monitor (locally or remotely) and optionally record for later review the conditions and activity that has been carried out within and around the enclosure. This information can be used for example to compile maintenance records, for quality assurance and safety compliance.

In a preferred embodiment, the enclosure has a control box to provide temperature, humidity and contamination controlled air to the inside the enclosure. In one embodiment, the control box is external and separate from the enclosure and the conditioned air is fed in to the enclosure via a duct or tube or pipe. In an alternative embodiment, the control box and air conditioning and supply may be integrated with the enclosure. The control box may optionally be connected to sensors inside the enclosure so that the internal working conditions can be maintained within specification and recorded. In an alternative embodiment, the control of the internal environment is maintained by open loop control. In one embodiment, the enclosure incorporates an exhaust that ensures air is vented in a controlled manner for example so as to avoid inhalation of dust and fumes by the operators and contamination of the work.

The enclosure may optionally be used in conjunction with an awning to provide additional shelter from weather such as precipitation, wind and direct sunlight.

In a preferred embodiment, the awning is made substantially from flexible materials, such as waterproof fabric. In an alternative embodiment, the awning is substantially rigid or semi-rigid.

In a preferred embodiment, the awning is closely attached to the work surface using a seal arrangement that prevents or reduces water from running down the surface of the structure into the work area.

The awning is held in position and tensioned to achieve the desired shape using means such as guy lines, cords, straps, poles, battens, etc., attached and adjusted with clips, karabiners, buckles, runners, linelocks, hooks, rings, knots, etc. to the work structure or access platform.

It is envisioned that the enclosure is flexible so that it can bend to conform to different shaped structures or parts of structures, work situations and tasks. It is envisioned that the enclosure and awning will be produced in different sizes to adapt to different sizes and shapes of work area and work task. In an alternative embodiment, the enclosure may be formed of modular panels and components that may be assembled together to adapt the shape and size of the enclosure to specific structures, work situations and tasks.

Particular embodiments of the enclosure may be adapted to conform to different structures by altering the shape of the enclosure. For example, the enclosure may be adapted to conform to a curved surface by shaping one or more edges of the enclosure to fit said curved surface.

In a particularly preferred embodiment, the enclosure is configured to enclose a leading edge, or a trailing edge, of a wind turbine blade. In order to make the enclosure suitable to enclose a leading edge, the enclosure may have a substantially cylindrical shape, with a U- or V-shaped notch removed from the closed upper and lower surfaces (ends) of the cylinder. By matching the shape of this notch to the profile of the leading edge, the enclosure may be configured to enclose and seal to the portion of the leading edge that is in need of repair. Embodiments of the invention may thus provide a waterproof temperature and humidity controlled enclosure that is small and simple that fits just round the work area in comparison with previous arrangements for housing operators carrying out such repairs outdoors, that enclose large volumes. This has several advantages:

A smaller lighter simpler system reduces the setup and packing up time and simplifies the procedure.

A smaller system reduces the tendency of the enclosure to catch the wind, particularly if used at height from a platform on a wind turbine blade for example, increasing the wind speed in which the enclosure can be deployed safely and effectively, and reducing the risk of damage or harm to the operators if the wind suddenly increases.

A small enclosure is quicker to bring the enclosed volume to the desired climatic conditions and requires less power.

A small enclosure uses fewer materials and is cheaper to manufacture.

The design of the flexible temporary enclosure is easily adaptable to different shapes and sizes of work area such as different types of turbine and different work tasks. The use of modular components for the enclosure enables the enclosure to be easily adapted to different shapes and sizes of work area and work situations.

### DESCRIPTION OF SPECIFIC EMBODIMENTS OF THE INVENTION

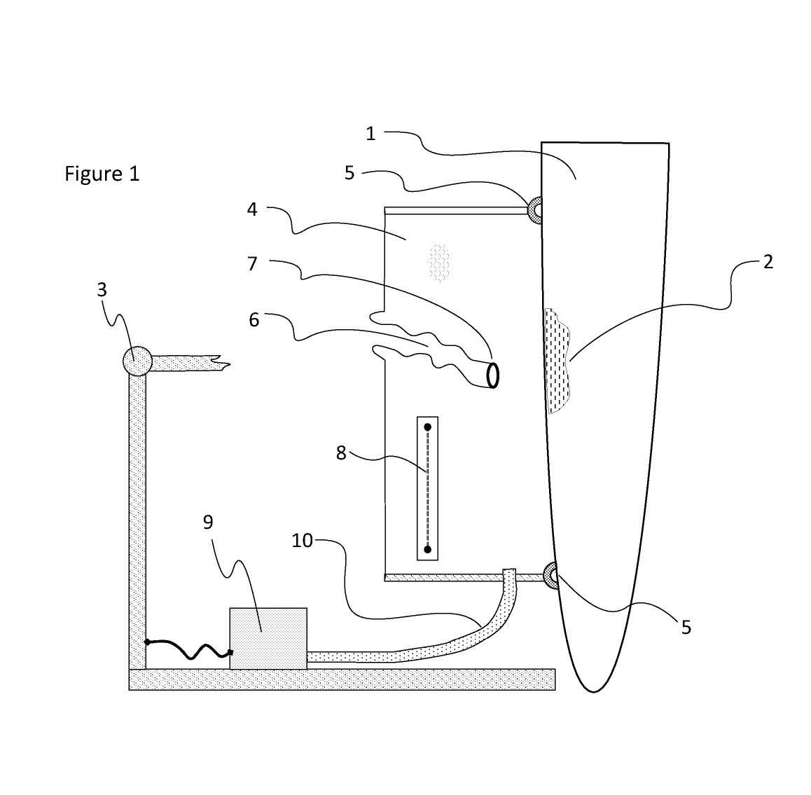

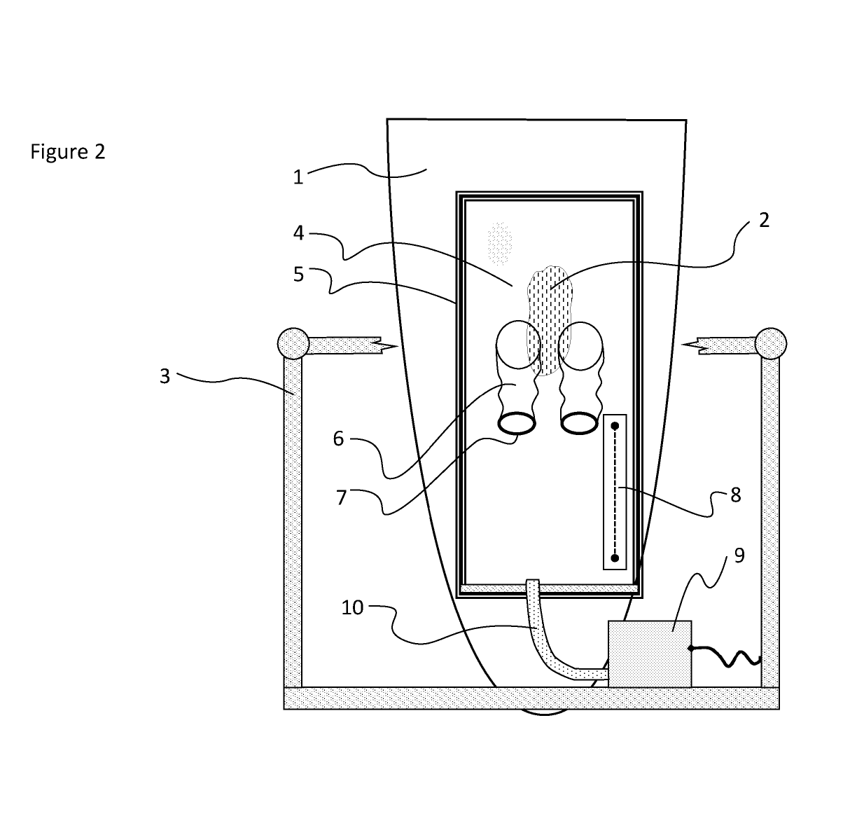

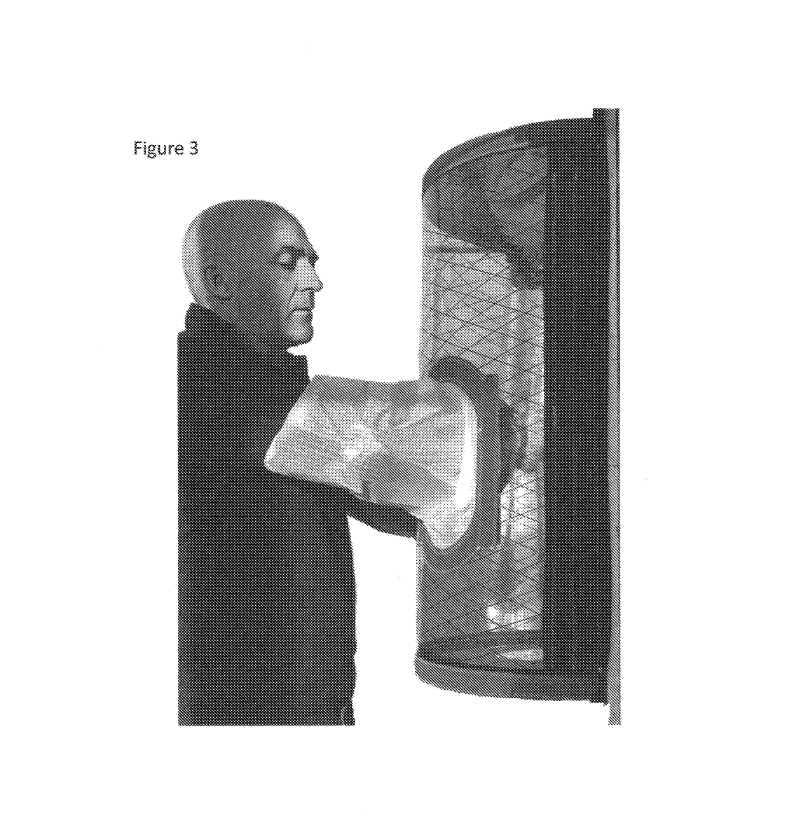

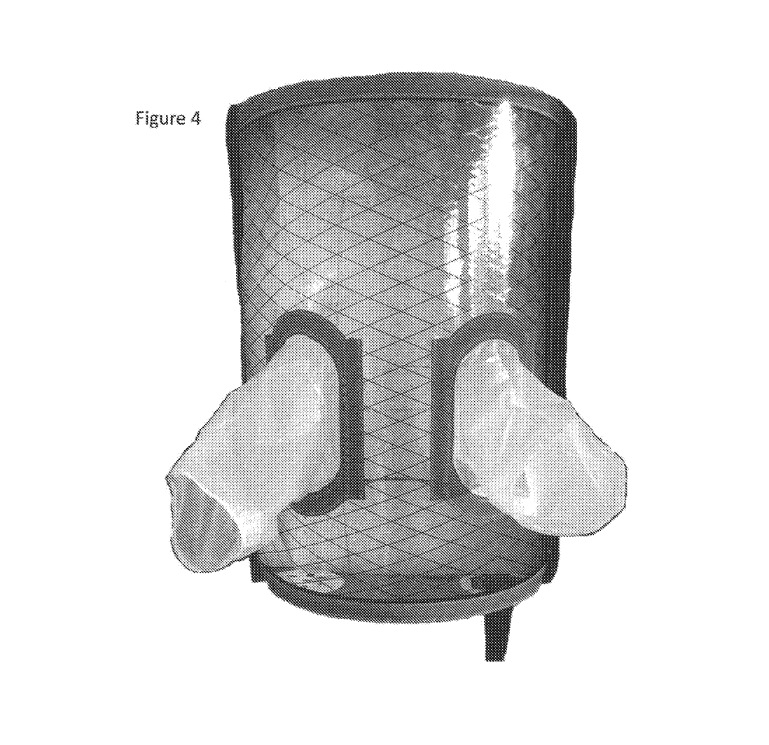

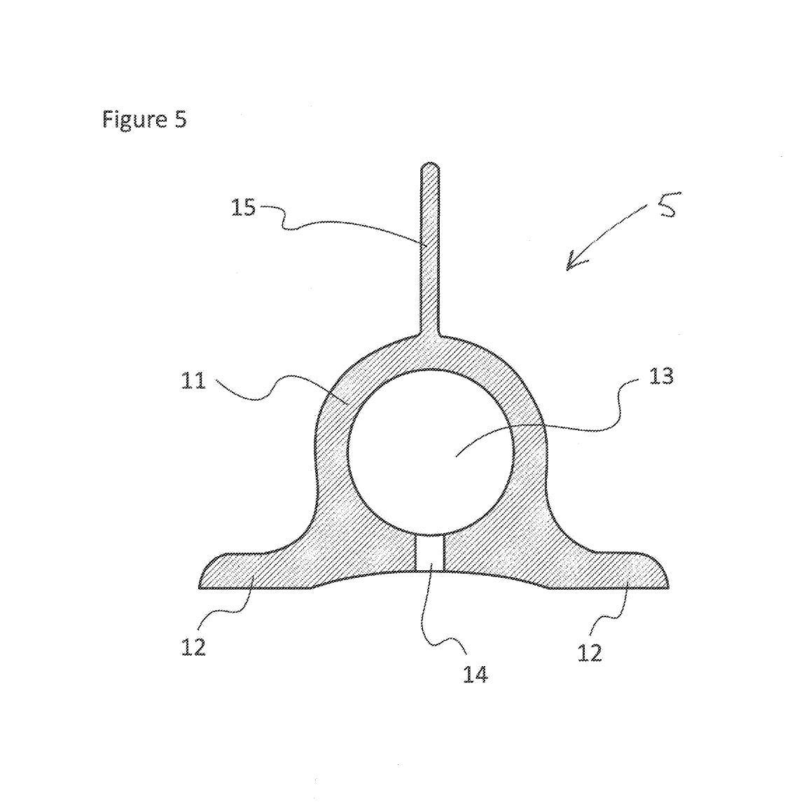

Embodiments of the invention are illustrated in FIGS. 1 and 2, in side view and front view. Photographs of one embodiment are shown in FIGS. 3 and 4, in side view and front view. A detail of a vacuum seal used in one embodiment is illustrated in FIG. 5, in cross section.

FIG. 1 illustrates an embodiment of the invention in use to undertake a repair on a wind turbine blade, in side view;

FIG. 2 illustrates an embodiment of the invention in use to undertake a repair on a wind turbine blade, in front view;

FIG. 3 shows a side view of a first embodiment of the invention being demonstrated with an operator;

FIG. 4 shows a front view of the first embodiment of the invention shown in FIG. 3;

FIG. 5 is a cross-section of a vacuum seal;

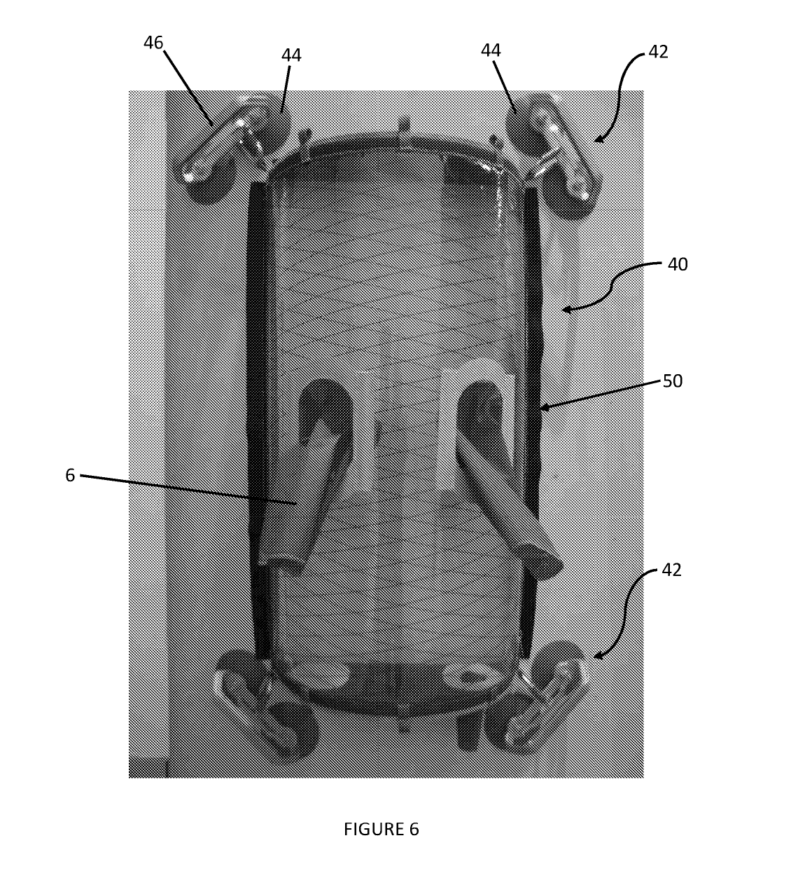

FIG. 6 is a front view of a second embodiment of the invention;

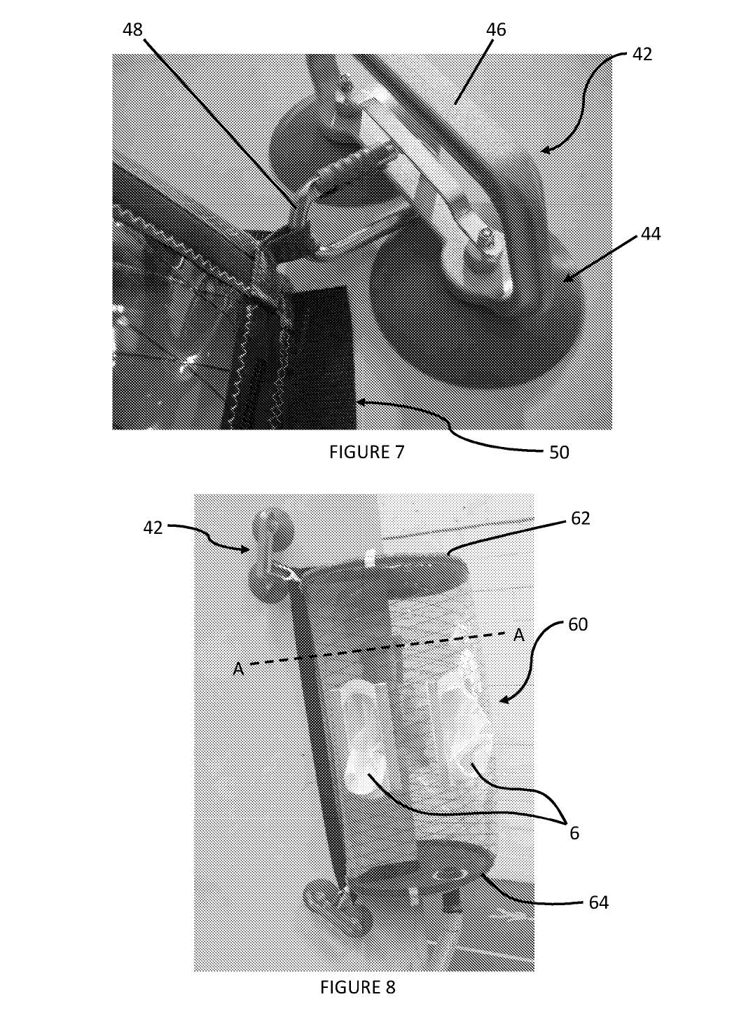

FIG. 7 is an enlarged view of the second embodiment of the invention shown in FIG. 6;

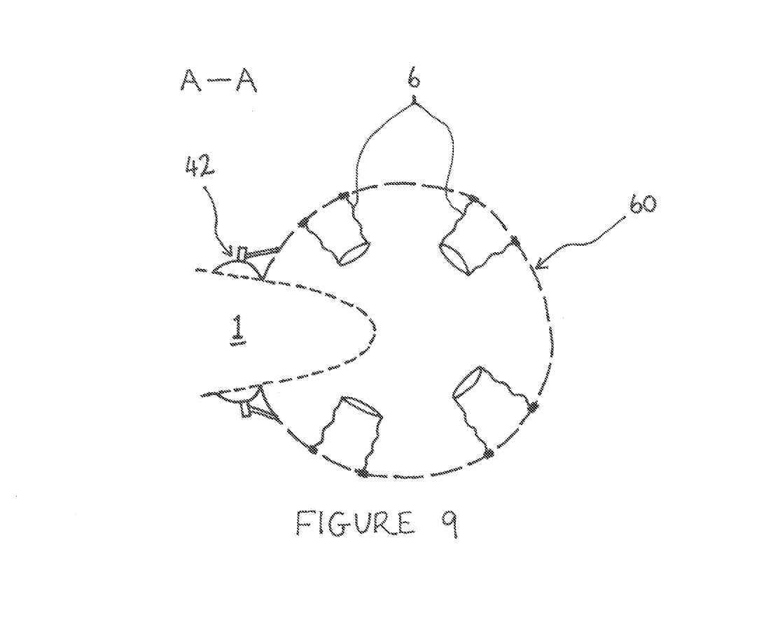

FIG. 8 is a perspective view of a third embodiment of the invention; and

FIG. 9 is a cross section of the third embodiment of the invention shown in FIG. 8.

The temporary enclosure is deployed onto a structure such as a wind turbine blade 1 in FIGS. 1 and 2. The work area 2 may for example require repair or painting or inspection. The work area may be accessed from an access platform 3 which could for example be suspended from the structure or supported by a truck mounted system. The access platform may advantageously be a conventional access platform. No modification of such conventional apparatus may be required to operate with embodiments of the present invention. (The access platform 3 is represented diagrammatically in FIGS. 1 and 2, and cut away to allow clearer illustration of the enclosure.) The temporary enclosure 4 is of dimension about 1 m by 1 m, and about 0.5 m deep, and is set up to surround the work area 2. The perimeter of the enclosure 4 is held in close contact with the surface of the structure by means of seals 5, which may for example use vacuum, supplied by a vacuum pump (not shown) so that that they form a seal with the surface.

FIG. 5 illustrates a suitable vacuum seal, in cross-section. The seal is extruded, with this cross-section, from an elastomeric material such as silicone rubber. As shown in FIG. 5, the seal has a central circular portion containing a bore 13 that extends throughout the length of the seal. The central circular portion is sufficiently rigid that it maintains its shape when air is drawn out of the bore by a vacuum pump or suction pump (not shown) during operation. A row of holes 14 extends outwardly from the bore on one side of the central portion of the seal, opening towards the surface of the blade or other structure during use. Two flanges 12 extend from the central portion, one on each side of the row of holes, and press against the surface in use in order to prevent or reduce any flow of air between the seal and the surface. The width of the seal across the flanges is approximately 40 mm. The seal 5 also has a flange 15 extending from the central portion opposite to the row of holes, by which it is attached to the rest of the enclosure 4 by stitching or adhesive. The seal extends around the entire perimeter of the enclosure, and the bore is couplable by a suitable pipe or tube to a vacuum pump or suction pump (not shown). When the internal air pressure in the bore is reduced, atmospheric pressure thus causes the flanges 12 to make close contact with the surface, holding the seal against the surface.

The enclosure 4 has areas that are essentially transparent, enabling the operator to see the work area 2 from outside the enclosure 4. The operator is able to reach into the enclosure 4 and carry out repairs and other work on the work area 2 through arm holes fitted with sleeves 6 that are adjustable or elasticated to form close seals 7 around the operator's wrists or arms. A port 8 is provided to pass tools, materials and other items into the enclosure, resealable with a zip or similar closure system. A similar port could also facilitate a power supply to be provided within the enclosure if desired. A climate control box 9 conditions air for temperature, humidity and cleanliness and passes this into the enclosure 4 through a flexible duct 10.

FIGS. 6 and 7 illustrate a temporary enclosure 40 according to a second embodiment of the present invention. The enclosure of the second embodiment is substantially as the first embodiment described above in relation to FIGS. 1 to 4, except that the enclosure 40 of FIG. 6 does not comprise a vacuum seal around its perimeter. The enclosure 40 is securable to the surface of a structure such as a wind turbine blade 1 by four suction-cup devices 42. Each suction-cup device 42 is made up of two suction cups 44 connected together by a handle 46. Fabric loops on each corner of the enclosure 40 are attachable to the handles of the suction-cup devices 42 by karabiners 48. By adjusting the position at which the suction-cup devices are secured to the surface, the edges of the enclosure 40 can be tensioned so that the enclosure adopts its intended shape.

Strips of fabric webbing 50 are attached to the enclosure 40 around its perimeter. When the enclosure and the suction-cup devices 42 are secured to the surface of a structure, the tension along the edges of the enclosure urges the webbing 50 into contact with the surface so as to form a seal. The seal between the webbing and the surface prevents, or reduces, the passage into the enclosure of outside contaminants such as water, and restricts the passage of air in and out of the enclosure so that a controlled atmosphere can be maintained within the enclosure.

FIGS. 8 and 9 show a temporary enclosure 60 according to a third embodiment of the present invention. The enclosure 60 is substantially as described above in relation to FIGS. 6 and 7, except that it has been adapted for use on a leading edge of a wind turbine blade 1.

In order to make the enclosure 60 suitable for attachment to a leading edge of a wind turbine blade 1, an upper surface 62 and a lower surface 64 of the enclosure 60 are shaped to conform to the contours of the leading edge. That is, the upper and lower surfaces contain a U or V-shaped notch shaped to receive the leading edge of a turbine blade 1. This is different to the enclosures 4, 40 of the first and second embodiments, which have perimeters adapted to engage substantially flat, or slightly curved, surfaces. This notched shape advantageously allows the enclosure 60 to be secured to and enclose a work area on the leading edge of a turbine blade, which is the portion that most frequently requires repair.

In order to allow work to be carried out on both sides of the leading edge without repositioning the enclosure 60, the enclosure comprises four arm holes fitted with sleeves 6. This also advantageously allows two operators to carry out repairs and other work on the work area simultaneously.

By altering the shape of the notch in the upper and lower surfaces, or making the enclosure of a material sufficiently flexible to accommodate differently shaped blade edges, the enclosure 60 may be made suitable for enclosing the trailing edge of a wind turbine blade.

### Further Embodiments and Features

During in situ repair or other work carried out on structures such as wind turbine blades, the working area is exposed to the weather and contamination. Exposure to conditions outside the use specification of repair processes or materials could limit the conditions in which the repair can be done or reduce the integrity of the repair. To provide protection, the enclosure and method of the invention provides a temporary shelter, or ‘habitat’, around the working area.

As listed below, embodiments of the invention may optionally incorporate a number of features in order to provide a controlled environment for repairs, in a ‘glove bag’ type bubble enclosure, with an open face that is sealed against the blade, and around the leading or trailing edge of a blade if required.

A preferred embodiment of the glove bag enclosure is supplied with filtered heated air to maintain a desired environment within the enclosure, and optionally to maintain a positive pressure. It has sleeves for the technician's arms, a clear viewing panel, resealable access ports for tools and power cables, a horizontal bench surface and internal lighting for night working.

The structure will be lightweight, flexible, made mainly from fabric, could incorporate battens, poles or flexible hoops to maintain its shape (as with a tent), straps or cords to maintain tension and rubber seal section held against the blade. Access ports will be closed with zips or hook-and-loop fastener, or other resealable fastenings.

The enclosure can protect in situ repair work on a wind turbine blade from the weather and contamination.

The enclosure should maintain an internal environment with a temperature between 20° C. and 30° C., when the external ambient temperature may be between −5° C. to 30° C.

During curing of composite materials in the enclosure, the temperature of the composite workpiece should be maintained stable to within ±3° C. No cooling function may be required, but thermostatic control with a temperature sensor inside the working area is advantageous.

The system should maintain an internal environment with relative humidity below 70% non-condensing. When it is raining or foggy, the relative humidity is close to 100%. Relative humidity in the enclosure may be reduced by heating the air or alternatively by using a dehumidifier (which condenses moisture out of the air which is recirculated) or a desiccant (which chemically absorbs moisture). If the surface temperature is higher than the external ambient temperature, moisture is unlikely to condense on the surface of the blade or structure.

The system should maintain an internal environment with a predetermined air cleanliness, optionally consistent with use of input air filters to BS EN779.1.

The ventilation system should preferably change the air within the internal environment of the enclosure at a predetermined rate, such as a predetermined number of times per hour.

For a given internal volume, say 1 m³, the air flow rate into the environment can be calculated from the air changes an hour. For example to achieve 60 changes per hour will require 60 m³/hour of air flow or greater than 1 m³/minute. The airflow will be reduced by any filter at the air input to the enclosure, perhaps by up to 30%, so the fan delivering the air must deliver sufficient extra capacity, at least 1.4 m³/min. This could advantageously be achieved by a 119 mm axial fan, for example.

The air flow rate then determines the power of any heater required to maintain the required internal temperature: power=mass flow rate×specific heat capacity of air×temperature rise.

The system should prevent dust contamination of the internal environment during repairs, e.g. by providing filtered air at positive pressure.

The system should prevent ingress of water into the internal environment during repairs. Rain may be blown by light wind (<10 m/s) and water will run down the surface of the blade or structure. In addition to a water resistant enclosure, rain water running down the surface of the blade or structure must be diverted away e.g. with contact seals such as vacuum seals, with particular attention to the seal between the habitat and the blade above the working area.

The materials used for the enclosure should be non-combustible or fire-retardant.

The internal air in the enclosure is preferably vented and dispersed safely away from the operator.

The enclosure should provide shading from direct sunlight.

Ideally the system should be usable without limitations or causing concern in wind speeds of up to 12 m/s average with gusts up to 14 m/s (this being the safe operating wind speed limit for onshore wind turbine platforms and a practical limit for work on offshore platforms). In addition, then enclosure should survive without damage, or causing a safety hazard, wind speeds gusting up to 20 m/s. This is advantageously enabled by the small size of the enclosure, by comparison with prior art systems, minimising the enclosed volume required around a repair.

It is advantageously possible to set up the system ready for use within 10 minutes, and to recover the system and stow it within 5 minutes (for example, in the event of a change in weather).

The enclosure preferably provides a controlled internal working space at least 1000 mm wide, 1000 mm high and 500 mm from the surface of the blade. An operator can preferably insert both arms through sleeves into the internal working space, e.g. through elasticated or adjustable cuffs. This provides sufficient freedom of movement to carry out the repair procedures safely, comfortably and without difficulty. The operator is provided with a clear viewing panel that will allow the work to be carried safely, comfortably and without undue difficulty.

At least one resealable access port is provided so that tools and materials can be passed into the internal working space for use, and then sealed. The port should allow passing in and out of items with a maximum dimension of up to 300 mm. This is advantageously a linear opening, e.g. a zip, that is at least 500 mm long.

Power outlet sockets are provided within the working area, or a port is provided for passing power cables into the working area, large enough to pass an electrical plug, which can then seal around the cable(s). An access port resealable with hook-and-loop fastener would allow cables to pass then be resealed around the cables giving an adjustable snug fit. A linear opening at least 100 mm long is preferred. This feature could be combined with the access port if the positioning is practical.

There should be adequate light within the working space for the technician to illuminate and see the work easily. During daylight, diffuse light through the fabric may be sufficient.

For work at night, artificial lighting should be provided. LED lights may be preferred in order to avoid excessive heating in the enclosure. Suspension points above the working area should be provided to hang lights overhead.

The system should preferably operate from 115V to 240V, 50 or 60 Hz single phase AC supply from the platform or turbine auxiliary supply. The system may advantageously draw not more than 2000 W maximum. The system circuit should have an isolating switch and protective circuit breakers to prevent any operation or fault affecting the functioning of the platform.

The system should be light in weight (as it will be carried and deployed by hand, and it adds to the payload on the platform). The total weight of the system should not exceed 20 kg.

The system will be used in an industrial environment, sometimes offshore/marine. All parts (unless they are intentionally disposable/replaceable) should withstand normal use, handling, transport, deployment and recovery without damage or deterioration.

It should be possible to deploy, operate and recover the system correctly and without undue difficulty working from a suspended access platform, wearing the usual personnel protection equipment (gloves, helmet, eye protection, outdoor clothing, harness, fall arrest and work positioning lines, lifejacket, workboots, etc.). Ideally, no tools may be needed normally to deploy, operate and recover the enclosure. Where service access requires use of a tool (such as a screwdriver), this should be of a type readily available, and provided in the kit.

The enclosure system should be packable into ideally one (or as few as practicable) robust and waterproof cases or bags for storage, transport, deployment and use on site. The package should contain a complete kit of all items, including all tools and spares, needed for on-site use and support of one system. The weight of any item in its packing should be less than 25 kg maximum. Handles and attachment points should be provided for safe and easy lifting.

The system should be compatible with conventional access platforms, for accessing the blade or other structure for repair.

Advantageously, securing the enclosure to a blade or other structure does not damage the blade or structure, or require any modification to the blade or structure. The use of a vacuum seal may be particularly advantageous in this regards.

1. An apparatus comprising a temporary enclosure for, in use, enclosing a work area of a structure in need of repair, whereby an operator outside of the enclosure can access the work area through one or more holes or sleeves or gloves in a wall of the enclosure, the enclosure comprising a transparent portion through which the operator can view the work area.

2. An apparatus according to claim 1 that is made of flexible or partially rigid or rigid material that can be assembled near to the work area, deployed on the work area and removed from the work area for reuse.

3. An apparatus according to claim 1 or 2 that incorporates partially rigid or rigid members such as battens, poles, tubes or rods to support its structure.

4. An apparatus according to claim 1, 2 or 3 that incorporates tensioned elements such as guy lines, cords, webbing, elastic cord or straps to support its structure.

5. An apparatus according to any preceding claim that is made partly or wholly from essentially transparent materials.

6. An apparatus according to any preceding claim, in which the enclosure is sealable around the work area, using a seal held in close proximity to a surface of the structure in need of repair, so as to maintain a controlled environment within the enclosure.

7. An apparatus according to claim 6 whereby the seal is achieved through vacuum or pressure or adhesion or tension.

8. An apparatus according to any preceding claim whereby the enclosure is couplable to a supply of air that is conditioned to maintain desired conditions within the enclosure, that may include temperature, humidity, dust filtering, and control of contaminants.

9. An apparatus according to claim 8 comprising a duct, tube or pipe for the supply of the air.

10. An apparatus according to claim 8 or 9 comprising a climatic control unit for providing the air, that is partly or wholly integrated with the enclosure whereby it comprises a part of the wall or structure of the enclosure or is within the enclosure.

11. An apparatus according to any preceding claim comprising an exhaust that allows air to be vented, preferably in a controlled manner.

12. An apparatus according to any preceding claim incorporating one or more sealable openings in a wall of the enclosure, comprising arm holes or sleeves or gloves, to enable the operator to conduct the work within the enclosure.

13. An apparatus according to any preceding claim incorporating a port through which tools, materials or other items to be used in the work can be passed into the enclosure and removed from the enclosure, the port preferably being openable and resealable or closable.

14. An apparatus according to claim 13 in which the port is partially flexible and is sealable using a zip fastener or hook-and-loop material such as Velcro® or lacing or buttons or press studs or hook-and-eye closures or magnetic strips or similar means.

15. An apparatus according to any preceding claim comprising a power-access port for allowing access, in use, of a power supply such as a cable, pipe or transmission linkage whereby electrical or pneumatic or hydraulic or mechanical or thermal or other form of power can be made available within the enclosure; and whereby electronic instrumentation and signal cables can be linked.

16. An apparatus according to claim 15 in which the power-access port is partially flexible and is sealable around the power supply using a zip fastener or hook-and-loop material such as Velcro® or lacing or buttons or press studs or hook-and-eye closures or magnetic strips or similar means.

17. An apparatus according to any preceding claim, incorporating a power supply outlet whereby electrical or pneumatic or hydraulic or mechanical or thermal or other form of power may be made available within the enclosure.

18. An apparatus according to any preceding claim, in which the enclosure incorporates lighting.

19. An apparatus according to any preceding claim incorporating sensors, instrumentation or monitoring equipment to monitor (locally or remotely) and optionally record the conditions and activity within and around the enclosure.

20. An apparatus according to any preceding claim, in which the enclosure is attachable to the structure in need of repair by a plurality of removable anchor means, such as suction cups.

21. An apparatus according to any preceding claim, in which the enclosure comprises a notch configured to enclose the leading edge, or the trailing edge, or another portion, of a wind turbine blade.

22. An apparatus according to any preceding claim, further comprising an awning usable in conjunction with or independently of the enclosure to provide shelter from the weather.

23. An apparatus according to claim 22 in which the awning is made of flexible or partially rigid or rigid material that can be assembled near to work area and deployed on the work area.

24. An apparatus according to claim 22 or 23 in which the awning incorporates rigid or partially rigid members such as battens, poles, tubes, rods, etc. to support its structure.

25. An apparatus according to any of claims 22 to 24 in which the awning incorporates tensioned elements such as guy lines, cords, webbing, straps, etc. to support its structure.

26. An apparatus according to any of claims 22 to 25 in which the awning incorporates a seal arrangement that can be held in close proximity to the work surface so as to prevent or reduce water from running down the surface into the work area.

27. An apparatus according to any preceding claim, in which the enclosure is flexible or partially flexible to adapt to different shapes of work surface, or different positions on a wind turbine blade, or different designs of wind turbine blade, or different work tasks.

28. An apparatus according to any preceding claim in which the enclosure is modular so that components of the enclosure can be assembled as required to enable it to be adapted to different shapes of work surface, or different positions on a wind turbine blade, or different designs of wind turbine blade, or different work tasks.

29. A method for repairing a structure comprising the steps of:
enclosing a work area of the structure in need of repair within an enclosure as defined in any preceding claim; and
accessing the work area by means of the one or more holes or sleeves or gloves in a wall of the enclosure, while viewing the work area through the transparent portion of the enclosure.

30. A method according to claim 29, further comprising the step of sealing an edge of the enclosure to a surface of the structure.

31. A method according to claim 29 or 30, further comprising the step of coupling the enclosure to a supply of air, the air preferably being conditioned for supply to the enclosure.

32. A method according to any of claims 29 to 31, further comprising passing tools, materials or other items into the enclosure through an openable and resealable port.

33. A method according to any of claims 29 to 32, further comprising coupling a power supply to the enclosure, by means of a power-access port of the enclosure.

34. An enclosure substantially as described herein, with reference to the accompanying drawings.

35. A method for operating an enclosure substantially as described herein, with reference to the accompanying drawings.
